(19) United States
(12) Patent Application Publication
(10) Pub. No.: US 2008/0142269 A1
(43) Pub. Date: Jun. 19, 2008

(54) BI STABLE ACTUATOR AND DRILLING SYSTEM INLCUDING SAME

(76) Inventors: Edward Richards, (US); David L. Smith, Sugar Land, TX (US); Geoff Downton, Gloucestershire (GB)

Correspondence Address: SCHLUMBERGER OILFIELD SERVICES, 200 GILLINGHAM LANE, MD 200-9, SUGAR LAND, TX, 77478, US

(21) Appl. No.: 11/609,996

(22) Filed: Dec. 13, 2006

(51) Int. Cl. E21B 7/04; H01F 7/06

(52) U.S. Cl. 175/76; 335/220

(57) ABSTRACT

A bi-stable actuator comprises a chamber 40 having a fluid inlet 34 and first and second fluid outlets 36, 38, a valve member 42 movable between a first position in which it co-operates with a first seat to close the first outlet 36 and a second position in which it co-operates with a second seat to close the second outlet 38, and an electromagnetic actuator 48 operable to drive the valve member 42 between its first and second positions, wherein the valve member 42 has a first surface 44 against which the fluid pressure within the chamber 40 acts when the valve member 42 is in its first position to resist movement of the valve member 42, and a second surface 46 against which the fluid pressure within the chamber 40 acts when the valve member 42 is in its second position to resist movement of the valve member 42.

This invention relates to a bi-stable actuator and to a drilling system including such an actuator.

### BACKGROUND OF THE INVENTION

Steerable drilling systems for use in the formation of boreholes, for example for subsequent use in the extraction of oil or gas are well known. One form of steerable drilling system includes a bias unit comprising a housing upon which a plurality of bias pads are carried. Each pad is movable between a radially retracted position and a radially extended position in which it bears against the wall of the borehole. The pads are movable by pistons to which drilling fluid or mud can be ported through a valve arrangement. By moving the pads to their extended positions in turn in a manner synchronised with the rotation of the housing, in use, the engagement of the pads against the borehole wall applies a laterally directed reaction force to the housing in a substantially constant direction. It will be appreciated that a drill bit carried by the housing can be urged in a chosen direction using such a technique, thus achieving control over the drilling direction.

### SUMMARY OF THE INVENTION

The control valve arrangement typically comprises a rotary face-sealing valve. Rather than use such a rotary valve, the use of a plurality of bi-stable actuators and associated valves has been considered. Bi-stable actuators are advantageous in that they only draw power during switching between their stable states.

One form of bi-stable actuators is described in U.S. Pat. No. 6,028,499. This actuator uses a permanent magnet to hold an actuator member in its stable positions, an electromagnet being used, when desired, to move the actuator member between these positions. Although such an arrangement is advantageous in that power is only consumed during switching, it has the disadvantage that a significant proportion of the power consumed is used simply in overcoming the biassing loads applied to the actuator member by the permanent magnet.

It is an object of the invention to provide a bi-stable actuator in which less power is consumed in switching the actuator between its stable states.

According to the invention, there is provided a bi-stable actuator comprising a chamber having a fluid inlet and first and second fluid outlet, a valve member movable between a first position in which it co-operates with a first seat to close the first outlet and a second position in which it co-operates with a second seat to close the second outlet, and an electromagnetic actuator operable to drive the valve member between its first and second positions, wherein the valve member has a first surface against which the fluid pressure within the chamber acts when the valve member is in its first position to resist movement of the valve member, and a second surface against which the fluid pressure within the chamber acts when the valve member is in its second position to resist movement of the valve member.

In such an arrangement, to switch between its stable conditions the electromagnetic actuator needs only to be capable of overcoming the action of the fluid pressure acting against the relevant one of the first and second surfaces, rather than being capable of overcoming, for example, a magnetically or mechanically applied biassing load. Consequently, less power is consumed. Further, it may be possible to use an actuator of smaller size. A further advantage is that, by avoiding the use of a magnet, the collection of magnetic debris on and around the bi-stable actuator can be reduced.

The invention also relates to a bias unit comprising a housing having a plurality of bias pads carried thereby, each bias pad being movable by an associated piston, and a bi-stable actuator of the type described herein before associated with each piston to control the supply of fluid under pressure thereto.

### BRIEF DESCRIPTION OF THE DRAWINGS

The invention will further be described, by way of example, with reference to the accompanying drawings, in which:

FIG. 1 is a diagrammatic view illustrating part of a steerable drilling system; and

FIG. 2 is a diagrammatic view illustrating a bi-stable actuator used in the system of FIG. 1.

### DETAILED DESCRIPTION

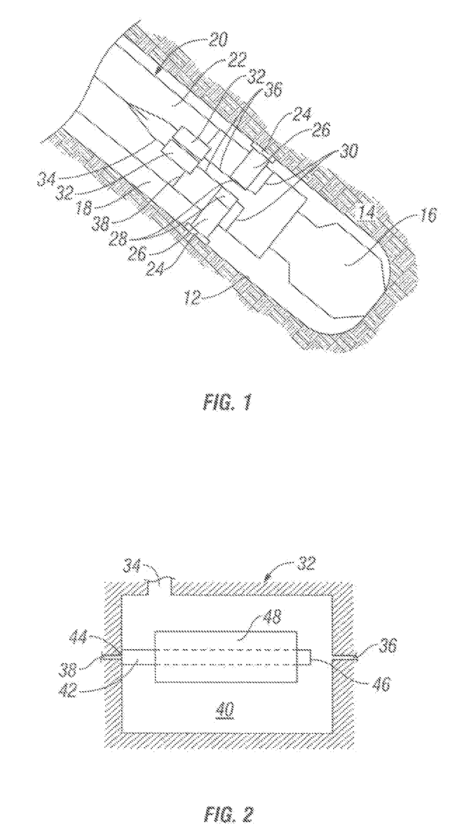

FIG. 1 illustrates, in part, a steerable drilling system 10 for use in the formation of a borehole 12 in a subsurface formation 14. The steerable drilling system comprises a drill bit 16 arranged to be rotated whilst a load is applied thereto to abrade, gouge or otherwise remove material from the formation 14 to extend the borehole 12. The formation material removed by the bit 16 is washed away using drilling fluid supplied through a drill string, the drilling fluid returning to the surface through an annulus 18 defined between the drill string and the wall of the borehole 12. The drill bit 16 may be rotated by, for example, a fluid driven motor located within the borehole 12. Alternatively, the drill bit 16 may be rotated by a motor located at the surface, the rotary motion being transmitted to the drill bit 16 from the surface through the drill string.

The drill string incorporates a number of components, for example stabilisers to assist in maintaining the drill string in the desired location aid to allow the application of the necessary load to the drill bit 16, and instrumentation for example to determine the orientation of the drill bit 16 and the direction in which drilling is occurring.

One of the drill string components is a bias unit 20 illustrated in part in FIG. 1. The bias unit 20 comprises a housing 22 upon which a plurality of bias pads 24 are carried. The bias pads 24 are each movable between respective radially retracted positions and radially extended positions. Movement of the bias pads 24 between these positions is achieved by means of associated pistons 26 reciprocable within corresponding cylinders 28. It will be appreciated that when the respective cylinders 28 are supplied with fluid under pressure, the pistons 26 are forced outwardly pushing the associated bias pads 24 into engagement with the wall of the borehole 12, and the resultant reaction force experienced by the housing 22 results in a laterally directed force being applied to the drill bit 16 which is connected to the housing 22. When fluid under pressure is not supplied to the cylinders 28, the co-operation between the bias pads 24 and the wall of the borehole 12 will force the associated pistons 26 back towards their retracted positions, fluid escaping from the cylinders 28 to the annulus 18 via restricted flow paths 30. Although the restricted flow paths 30 are illustrated diagrammatically as forming part of the housing 24, it will be appreciated that these flow paths may be achieved in a number of ways. For example, the flow paths may be defined by small clearances between the pistons 26 and associated cylinders 28 or may be defined by passages formed in the pistons 26.

As described hereinbefore, a rotary face sealing valve has typically been used to control the supply of fluid under pressure to the cylinders 28. In accordance with the invention, rather than using a rotary face sealing valve to achieve this function, a plurality of bi-stable actuators are used, each actuator 32 being associated with a respective one of the pistons 26 and associated cylinders 28. The actuators 32 are controlled so as to control the position occupied by each piston 26 and the bias pad 24 associated therewith at any given time. It will be appreciated that by controlling the positions occupied by the bias pads 24 in a relationship synchronised with the rotation of the housing 22, the steerable drilling system 10 can be operated in such a manner that a laterally directed force acting in a substantially uniform direction can be applied to the drill bit 16 urging the drill bit 16 to form a curve or dog leg in the borehole 12.

As illustrated in the drawings, each actuator 32 includes an inlet 34 to which drilling fluid under pressure is supplied from the drill string. Each actuator 32 further includes a first outlet 36 which communicates with the cylinder 28 of the piston and cylinder 26, 28 with which the valve 32 is associated. A second outlet 38 of the actuator 32 communicates with the annulus 18 through a restricted flow passage. The inlet 34 and first and second outlets 36, 38 all communicate with a chamber 40 formed in the actuator 32. Located within the chamber 40 is a valve member 42, the valve member 42 being guided for reciprocating movement between a first position in which the valve member 42 engages a seating associated with the first outlet 36, closing the first outlet 36, fluid being able to flow from the inlet 34 to the chamber 40 and through the second outlet 38 with the valve member 42 in this position and a second position in which the valve member 42 engages a seating associated with the second outlet 38, closing the second outlet 38 whilst permitting fluid to flow from the inlet 34 through the chamber 40 to the first outlet 36. FIG. 2 illustrates the actuator with the valve member 42 in its second position. The valve member 42 has a first surface 44 against which the fluid pressure within the chamber 40 acts when the valve member 42 is in its first position, the fluid pressure applying a force to the valve member 42 holding it in its first position. Similarly, the valve member 42 includes a second surface 46 orientated such that when the valve member 42 occupies its second position, the action of the fluid under pressure within the chamber 42 on the second surface 46 resists movement of the valve member 42 away from its second position. An electromagnetic actuator arrangement 48 is provided to drive the valve member 42 between its first and second positions.

With the valve member 42 in the position illustrated in FIG. 2, it will be appreciated that fluid under pressure is applied to the first outlet 36, thus the cylinder 28 with which the actuator 32 is associated is supplied with fluid under pressure urging the respective piston 26 and bias pad 24 towards its extended position and thus resulting in the application of a laterally directed force to the drill bit 16. As fluid is only able to escape from the cylinder 26 at a restricted rate through the restricted passage 30, it will be appreciated that only a relatively small quantity of fluid will flow through the actuator 32 to the cylinder 28, and that the fluid pressure within the chamber 40 will very rapidly rise resulting in a relatively large magnitude force being applied via the second surface 46 to the valve member 42 thus ensuring that the valve member 42 will not move from the position illustrated.

When it is desired to allow the associated piston 26 and bias pad 24 to move towards its retracted position, the electromagnet actuator arrangement 48 is operated to apply a force to the valve member 42 to cause the valve member 42 to move towards its first position. It will be appreciated that in order to do this, the actuator 48 must be able to apply a sufficiently large force to overcome the hydrostatic force applied via the second surface 46. However once movement of the valve member 42 has commenced, it will be appreciated that this force will rapidly diminish as both the first and second surfaces of the valve member are exposed to the fluid pressure and so for the majority of the movement of the valve member 42, the load against which the electromagnetic actuator 48 must act is relatively low. Once the electromagnetic actuator 48 has moved the valve member 42 to its first position, it will be appreciated that the valve member 42 closes the first outlet 36 and instead communication is established between the chamber 40 and the second outlet 38. As communication is broken between the chamber 40 and the first outlet 36, it will be appreciated that the fluid pressure within the associated cylinder 28 will fall, fluid escaping through the restricted flow passage 30, thus enabling the piston 26 and bias pad 24 to return to their retracted conditions. As, illustrated in FIG. 1, the second outlet 38 forms a restricted flow path to the annulus 18. As the flow of fluid to the annulus 18 is restricted, it will be appreciated the fluid pressure within the chamber 40 will rapidly rise, the fluid pressure acting upon the first surface 44 of the valve member 42 thus applying a relatively large magnitude force to the valve member 42 holding the valve member 42 in its first position.

As the valve member 42 is held in both its first and second stable positions by means of the applied fluid pressure, it will be appreciated at the electromagnetic actuator 48 does not need to be energised other than when it is desired to move the valve member 42 between its first and second positions. Clearly, this can result a reduction in the power consumed by the bias unit 20. Further, compared to bi-stable actuators of the type in which a magnetically applied or mechanically applied biassing force acts upon the valve member, the load against which the electromagnetic actuator 48 must act in order to move the valve member 42 between its first and second positions is relatively low thus achieving further savings in the power consumption of the bias unit 20. It may also be possible to use an actuator 48 of smaller dimensions.

As discussed hereinbefore, each time the actuator 34 is switched between its stable positions, the chamber 40 will experience a reduction in fluid pressure and will subsequently be re-pressurised, a quantity of fluid passing through the actuator 34 during each actuation. This quantity of fluid will be relatively small.

Compared to arrangements using bi-stable actuators of the type in which a permanent magnet is used to apply a biassing or latching force, the arrangement described hereinbefore is advantageous in that the absence of the provision of a permanent magnet reduces the risk of magnetic debris tending to collect around or in the actuator. Consequently, maintenance and servicing operations may be reduced.

It will be appreciated that a number of modifications and alterations to the arrangement described hereinbefore may be made without departing from the scope of the invention.

1. A bi-stable actuator comprising a chamber having a fluid inlet and first and second fluid outlets, a valve member movable between a first position in which it co-operates with a first seat to close the first outlet and a second position in which it co-operates with a second seat to close the second outlet, and an electromagnetic actuator operable to drive the valve member between its first and second positions, wherein the valve member has a first surface against which the fluid pressure within the chamber acts when the valve member is in its first position to resist movement of the valve member, and a second surface against which the fluid pressure within the chamber acts when the valve member is in its second position to resist movement of the valve member.

2. An actuator according to claim 1, wherein the inlet communicates with a source of fluid under pressure and first and second outlets communicate with low pressure sinks.

3. An actuator according to claim 2, wherein the communication between the first and second outlets and the respective low pressure sinks is restricted.

4. A bias unit comprising a housing having a plurality of bias pads carried thereby, each bias pad being movable by an associated piston, and a bi-stable actuator as claimed in any of the preceding claims associated with each piston to control the supply of fluid under pressure thereto.

5. A steerable drilling system incorporating a bias unit according to claim 4.
